(19) United States
(12) Patent Application Publication
(10) Pub. No.: US 2021/0214598 A1
(43) Pub. Date: Jul. 15, 2021

(54) Formed Polygon Structure Configured To Disperse A Material Upon Impact

(71) Applicant: Jack A. ATZMON, Pompton Lakes, NJ (US)

(72) Inventor: Jack A. ATZMON, Pompton Lakes, NJ (US)

(21) Appl. No.: 16/974,196

(22) PCT Filed: May 13, 2019
(86) PCT No.: PCT/US2019/031989

§ 371 Date: Nov. 12, 2020

Related U.S. Application Data
(60) Provisional application No. 62/670,790, filed on May 12, 2018.

(51) Int. Cl. C09K 3/18; E01H 10/00

(52) U.S. Cl. CPC C09K 3/185; A23P 30/10; E01H 10/00

(57) ABSTRACT

An ice melting compositions are formed into balls or other shapes. These balls, when thrown, impact the ground and are configured to provide approximately four (4) feet of dispersion spread. The balls are formed by pressure, bonded with urea, brine, or water, or built on a lattice.

### CROSS-REFERENCE TO RELATED APPLICATIONS

This application claims priority from U.S. Provisional Application No. 62/670,790, filed May 12, 2018, the entire contents of which hereby incorporated by reference.

### Field of the Invention

The present invention relates to dispersing salt and other ice melting or traction providing compositions and more particularly to formed salt balls configured to disperse upon impact with the ground.

### BACKGROUND OF THE INVENTION

Currently there are few ways to disperse ice melting and traction providing compositions. These compositions, comprise ice melting compositions including NaCl, CaCl, MgCl, urea, brine, and the like and traction compositions such as sand, clay, ash, gravel, and the like. To disperse these compositions, users typically use broadcast spreaders, drop spreaders, or toss handfuls of loose product. Using loose product and any of these dispersion methods results in unequal spreading of product and an excessive application of product.

### SUMMARY OF THE INVENTION

According to one aspect of the invention ice melting compositions are formed into balls or other shapes. These balls, when thrown, impact the ground and are configured to provide approximately four (4) feet of dispersion spread.

According to one aspect of the invention the invention, the formed shapes are formed by pressure, bonded with urea, brine, or water, built on a lattice, or the like. Agar agar can also be used as a bonding agent.

According to one aspect of the invention the formed shapes include both ice melting and traction providing compositions.

The invention is also applicable for other applications with other materials for use in fire prevention or extinguishing, ice melting, cooking, seasoning, or any other application for delivering a measured or unmeasured amount of material.

### BRIEF DESCRIPTION OF THE FIGURES

FIG. 1 is a salt ball;

FIG. 2 is a parfait style salty ball;

FIGS. 3A and 3B are a hollow ball;

FIG. 4A is a rolled mat;

FIG. 4B is an unrolled mat;

FIG. 5 is a measuring spoon with markings;

FIG. 6 is a ball with message; and

FIGS. 7-11 are various salt shapes.

### DETAILED DESCRIPTION OF THE INVENTION

The present invention provides a formed shape that disperses the constituent products of the formed shape upon impact. The formed shapes are generally stored at room temperature. The formed shapes can be stored in airtight containers, submerged in brine, or the like. Once the ice melting components are formed into shapes, even if formed using brine, the formed shape do not dissolve in brine.

In the following description, the formed shapes are described as balls. However, other shaped can be used. The formed shapes can be oval, square, octagons, tetrahedrons, rectangles, pucks, pyramids, pentagons, random polygons, jack-like shapes, crosses, or the like. In one embodiment, described in more detail below, the ice melt or traction product is formed as a flexible mat or roll. Additionally, while described using one material, multiple ice melting compositions can be used and the one or more ice melting compositions can be combined with one or more traction compositions. Still further, food grade constituents can be used for the formed shape.

According to one aspect of the invention, the balls are formed using pressure and a mold. For example, the ice melt composition is placed in a mold. The mold is then subject to a pressure for a given time. The preferred pressure is about 6 tons of pressure on the mold and once the pressure is achieved, the ball is formed. The time and pressure for forming the balls will vary based on the size of the ball and the composition of the materials used. The balls can be formed with a traction composition center. Alternatively, a traction composition can be interspersed with the ice melting components.

According to one aspect of the invention, the balls are formed using water. One type of ball is formed using CaCl. CaCl is placed in a mold. Water is used to bond the CaCl into balls at the connection points where the CaCl crystals meet.

Many materials can be used. CaCl provides good melting properties and is easy to bond. NaCl is a crystal and requires pressure to bond or another bonding process and its crystal structure acts like a framework and can be used to fill in the gaps. Other materials include MgCl, Urea, Brine, and sand with clay and agar agar. The formed balls, depending on the materials, can be stored at room temperature, in air-tight containers, or submerged in brine. A prefered embodiment uses a combination of NaCl, CaCl, and MgCl. Typically the blend includes 10% CaCl and 90% NaCl. Crystals are preferred to pellets. Fine crystals are preferably filtered out so that the medium and larger crystals are used to make the balls.

According to one aspect of the invention, the balls are formed using heat. The ice melt composition is placed in a mold which is subsequently heated. The heat applied to the mold will vary based at least in part on the ice melt composition. Alternatively, the ice melt composition is heated and then placed in the mold.

According to one aspect of the invention, the ice melting composition is formed into a matrix that is either substantially solid or a shell. The shell is configured like a “wiffle ball” or the like. The ice melt component is placed in a mold to form the structure. The shell structure can be filled with additional ice melting compositions, traction compositions, or the like.

According to one aspect of the concentric invention, the one or more ice melting compositions are layered to form a “parfait”. The layers can also include one or more traction compositions. Alternatively, the different layers can be provided as shell layers. The various shell layers are formed with increasing diameters. The layers can be the same compositions or different compositions.

According to one aspect of the invention, the balls are formed using a vacuum. The one or more ice melting compositions are placed in a mold that is evacuated. The vacuum causes the one or more ice melting compositions

According to one aspect of the invention, rock salt (NaCl) is mixed with CaCl. This mixture works well in the parfait configuration and the ball configuration.

According to one aspect of the invention, the balls are formed via air drying. Air drying worked particularly well with NaCl. Preferably, a baking soda paste is used to bond the NaCl into balls.

According to one aspect of the invention, the balls are sealed or coated using urea, brine, adhesive, or the like.

The present embodiment provides a solid sphere-like shape that disperses upon impact. The dispersion is approximately four feet and uses about 25% less ice melting material than standard applications.

To produce one embodiment of the shaped product, a single material is put into a hydraulic press. In one embodiment, the press is a 6-12 ton press. The mold is typically a 40 mm mold. Using a 6 ton press having 15.5 inch travel and an 11.5 inch total travel for the hydraulic arm, at rest, when no pressure is applied, the space between the mold halves is about 12.7 mm. the components being pressed include a 0.8 inch mold, a 0.2 inch iron brick, and a 0.5 inch metal sheet. Total travel to form the shapes elements is about 17.25 mm. The above uses medium grade crystals. It should be noted that the pressure will vary as the granule size changes. As the granule size decreases the pressure decreases and the time to fuse the balls decreases. Likewise, as the granule size increases the pressure to fuse the balls increases.

Different size granules have been used successfully, For example, using a 1/12″ sieve results in dust and fine particles, which yield acceptable results but not preferred. Using a 1/14″ sieve results in larger crystal sizes, which yield acceptable results. Using a ⅛″ sieve yields the best results.

For a typical production, the weights of the finished products vary from about 73 grams (2.5 ounces) to 95 grams (3.4 ounces) and the initial mold displacement varies from about 6.5 mm to about 11 mm.

To form the product, material, such as salt, is placed in the mold until about half full. The half full mold is then shaped with the top half of the mold. Salt is then added until full and shaped with the top half of the mold. The mold is compressed with a mallet, press or the like to form an initial product. A tool is then used to determine if additional salt is required. if more salt is required, it is added. The filled mold is then placed in a 6 ton press and compressed. The balls are then removed from the mold. The balls are removed using push pins, drilled and pulled, or pried out. In one embodiment, the balls are formed in a shipping package using vacuum.

In one embodiment, the balls are formed as a hollow shell. A 2 to 3 inch sphere is formed by melting material together or joining the material using urea, adhesive, or the like. In one embodiment, two halves are formed and then fused together. The halves can be fused with a water soluble stabilizer embodied as a microfiber sheet that dissolves in water. The two halves can be filled with a same or different material or left empty.

In one embodiment, the material is formed as a sheet or a mat. The material can be an ice melter or an ice melter mixed with sand. To form, an adhesive is sprayed and the material is added to the adhesive. This forms a mat of ice melting material that can be rolled into a roll and unrolled for application. As the snow or ice melts, the adhesive dissolves leaving substantially no residue. In one embodiment, the mat includes an accordion structure to account for curved applications.

In one embodiment, the material distribution element is formed as a lattice or exoskeleton of material, or a “wiffle-ball” shape. The lattice can be molded or built as a structure.

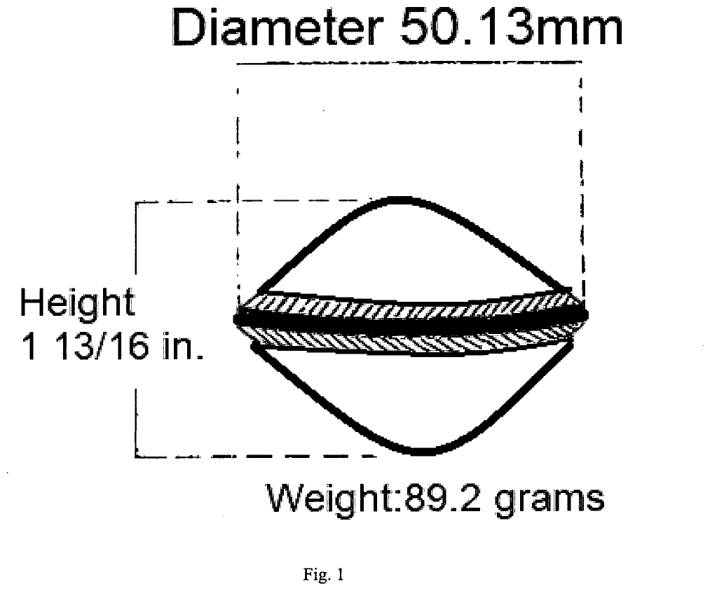

As shown in FIG. 1, the salt ball has a diameter of about 1.97 inches (50.13 mm) and a height of about 1 13/16 inches (46 mm). In one embodiment, the ball has a circumferential band that has a larger diameter. In other words, the circumferential bad extends from the ball. While the balls are formed as a solid mass, when tossed on a surface, the salt components of the ball disperse on the surface upon which the ball impacts.

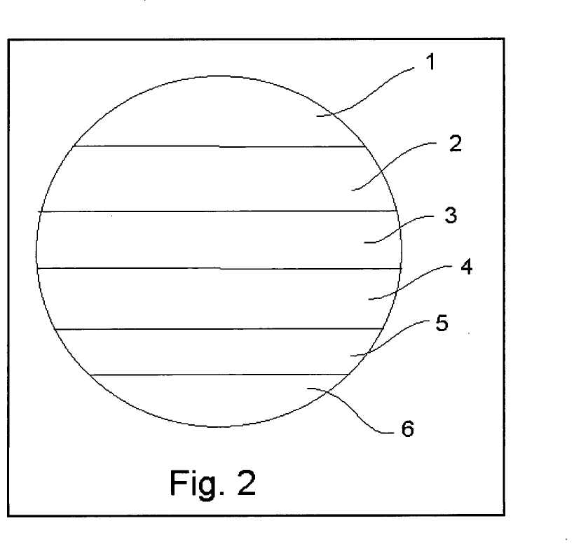

In one embodiment shown in FIG. 2, the material distribution element is formed as a layered laminate. The layers are either concentric formed as shells surrounding a hollow or filled center or a “parfait” formed as a plurality of layers. It should be noted that each of the embodiments disclosed herein can be formed from one or more materials. The parfait is formed in a manner similar to the ball embodiment and disperses in a similar manner. As shown, the parfait had six layers, 1-6. It should be noted that there may be as few as two layers or as many as 12. The layers may alternate. For example, the NaCl and the CaCl layers alternate. Alternatively, the layers are a blend of materials in different percentages.

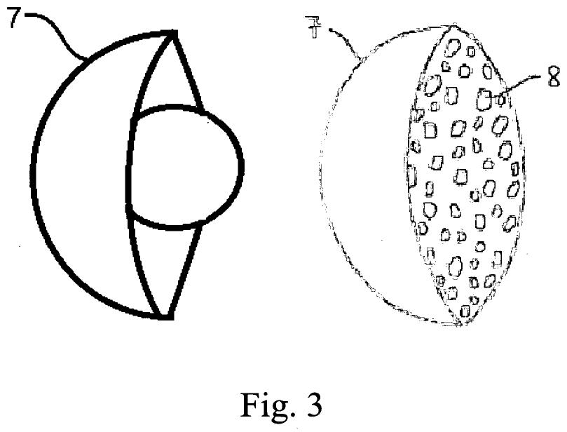

FIGS. 3A and 3B depict a hollow ball. The ball comprises a shell 7. The crystals of salt 8 form the walls of the hollow ball or shell. The Shells are manufactured in a manner similar to the balls and parfaits discussed above.

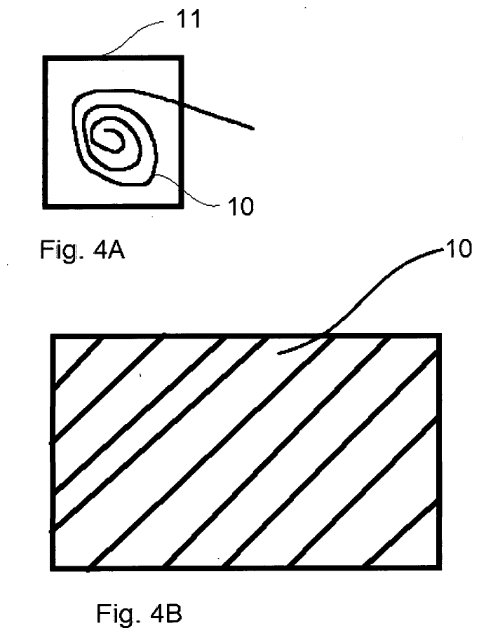

FIG. 4A shows a mat embodiment. The mat structure 10 can be rolled up and stored in a box or dispenser 11. In use, the mat 10 is unrolled and laid down at a desired location. The adhesive that retains the salt crystal dissolves leaving the salt crystals to melt the ice or snow.

It should be noted that water can be used as a bonding agent. Water produces an exothermic reaction with many of the previously mentioned materials. The bond is created by ionic hydrolysis. Alternatively, heat may be used. A heat gun or other method of applying heat can be used to melt urea to 240-250 degrees at which it becomes wax-like and acts as an adhesive. The material can be heated in the mold or heated prior to being placed in the mold.

The finished product can be sealed by coating the balls with urea or adhesive. Further brine can also be used as a coating agent.

Other uses include oil clean up. An oil absorbent material can be formed in balls or sheets for use in case of an oil spill or leak. Additionally, fire prevention or suppression materials can be used.

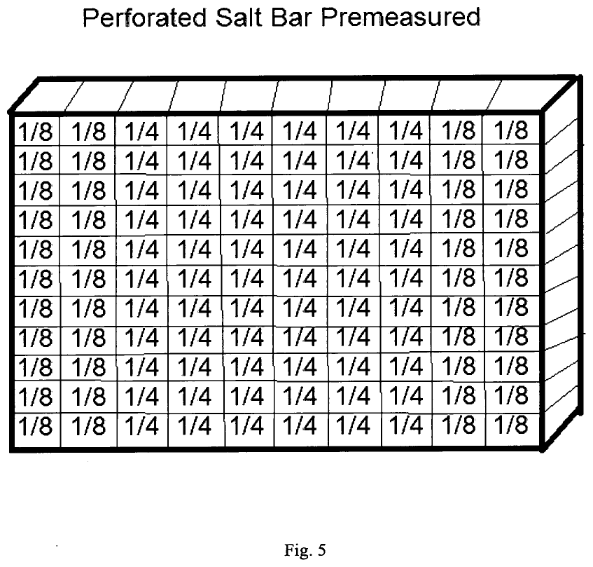

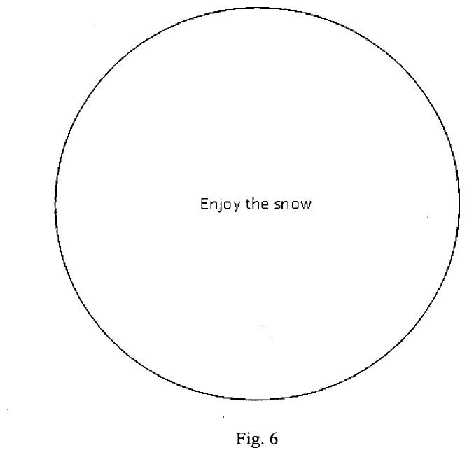

In one embodiment, cooking salt is formed in teaspoon or tablespoon size balls. These balls can be used for cooking purposes. the salts can be Himalayan salt, sea salt, or the like. Alternatively, the salt can be a perforated bar as shown in FIG. 5. As shown in FIG. 6 the balls can be colored or have messages printed on them. The messages can be holiday themed, or for a special occasion like a house warming.

In one embodiment, salt, sugar or other cooking materials are formed into shapes such as a measuring spoon. The measuring spoon can be a measured amount of salt such as a teaspoon or a tablespoon. The spoon can then be used for seasoning after it is used for measuring cooking ingredients. The measuring spoon can be scored so it can be easily divided into fixed portions. In one embodiment, the salt is formed into scored blocks that can be easily divided. The divideable segments are in standard measures such as ⅛ teaspoon, ¼ teaspoon, teaspoon, tablespoon, and the like.

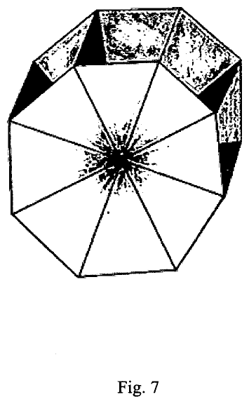

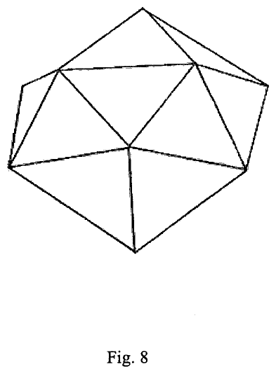

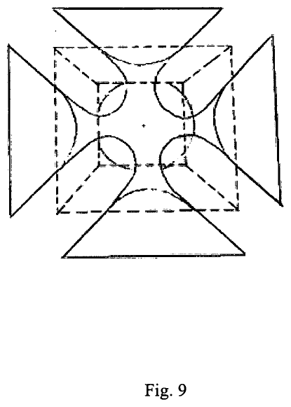

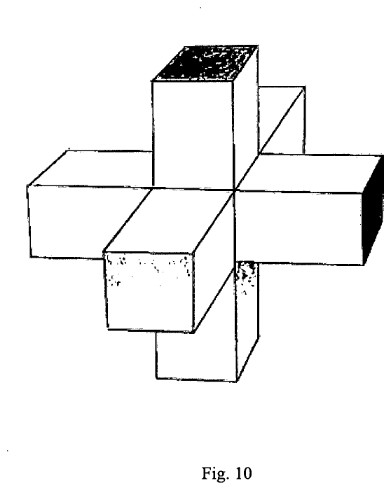

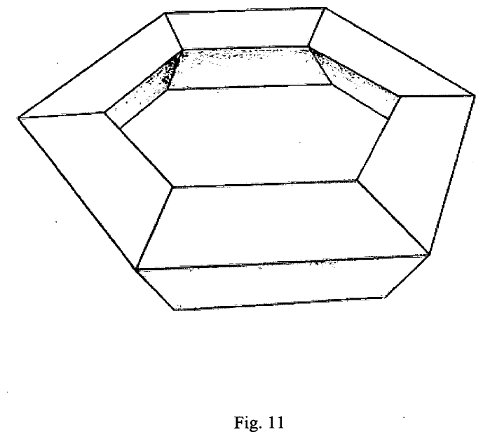

FIGS. 7-11 are various shapes including an octagon, diamond, crosses, and a ring.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A polygon formed from as structure that is configured to disperse upon impact comprising:
at least one salt, the salt being salt crystals;
a liquid used as a bonding agent,
wherein the salt is bonded into the polygon at connection points where the salt crystals touch.

2. The polygon of claim 1, wherein the salt is at least one of CaCl, Nacl, and MgCl.

3. The polygon of claim 1, wherein the salt comprises about 10% CaCl and about 90% NaCl.

4. The polygon of claim 1, wherein the salt crystals are passed through at least one of a 1/12″ sieve, a 1/14″ sieve, and a ⅛″ sieve prior to forming the polygon.

5. The polygon of claim 1, wherein the polygon is one of a ball, an octagon, diamond, crosses, and a ring.

6. The polygon of claim 1, further comprising a traction material.

7. The polygon of claim 6, wherein the traction material is one of sand and ash.

8. The polygon of claim 1, wherein the polygon is between about 2.5 ounces and 3.4 ounces and the dispersal is approximately four feet.

9. A method of forming a salt polygon comprising:
placing a salt composition in a mold;
placing the mold halving two mold halves in a hydraulic press; and applying pressure.

10. The method of claim 9, wherein the press is a 6-12 ton press having 15.5 inch travel and an 11.5 inch total travel.

11. The method of claim 10, wherein the mold is typically a 40 mm mold.

12. The method of claim 11, wherein at rest, when no pressure is applied, the space between the mold halves is about 12.7 mm.

13. The method of claim 12, wherein components being pressed include a 0.8 inch mold, a 0.2 inch iron brick, and a 0.5 inch metal sheet. and wherein total travel to form the salt polygon is about 17.25 mm.

14. The method of claim 13, further comprising using one of a 1/12″ sieve, a 1/14″ sieve, and a ⅛″ sieve to screen the salt composition.
